(19) United States
(12) Patent Application Publication
(10) Pub. No.: US 2025/0220543 A1
(43) Pub. Date: Jul. 3, 2025

(54) RADIO LINK FAILURE REPORTING FOR LOWER LAYER TRIGGERED MOBILITY

(71) Applicant: Samsung Electronics Co., Ltd., Suwon-si (KR)

(72) Inventor: Anil Agiwal, Allen, TX (US)

(21) Appl. No.: 18/959,420

(22) Filed: Nov. 25, 2024

Related U.S. Application Data
(60) Provisional application No. 63/615,190, filed on Dec. 27, 2023.

(51) Int. Cl. H04W 36/30; H04W 36/00; H04W 36/38

(52) U.S. Cl. CPC H04W 36/305; H04W 36/008357; H04W 36/38

(57) ABSTRACT

A user equipment includes a transceiver, and a processor operatively coupled to the transceiver. The transceiver is configured to receive, from a source cell, a conditional lower layer triggered mobility (LTM) configuration for at least one conditional LTM candidate cells. The processor is configured to initiate execution of a conditional LTM cell switch towards a target cell of the at least one conditional LTM candidate cells, determine that the conditional LTM cell switch towards the target cell has failed, and in response to the determination that the conditional LTM cell switch towards the target cell has failed, generate a radio link failure (RLF) report.

### CROSS-REFERENCE TO RELATED APPLICATION(S) AND CLAIM OF PRIORITY

This application claims priority under 35 U.S.C. § 119(e) to U.S. Provisional Patent Application No. 63/615,190 filed on Dec. 27, 2023. The above-identified provisional patent application is hereby incorporated by reference in its entirety.

### TECHNICAL FIELD

This disclosure relates generally to wireless networks. More specifically, this disclosure relates to radio link failure (RLF) reporting for lower layer triggered mobility (LTM).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for RLF reporting for LTM.

In one embodiment, a user equipment (UE) is provided. The UE includes a transceiver, and a processor operatively coupled to the transceiver. The transceiver is configured to receive, from a source cell, a conditional lower layer triggered mobility (LTM) configuration for at least one conditional LTM candidate cells. The processor is configured to initiate execution of a conditional LTM cell switch towards a target cell of the at least one conditional LTM candidate cells, determine that the conditional LTM cell switch towards the target cell has failed, and in response to the determination that the conditional LTM cell switch towards the target cell has failed, generate a radio link failure (RLF) report.

In another embodiment, a method of operating a UE is provided. The method includes receiving, from a source cell, a conditional LTM configuration for at least one conditional LTM candidate cells, and initiating execution of a conditional LTM cell switch towards a target cell of the at least one conditional LTM candidate cells. The method also includes determining that the conditional LTM cell switch towards the target cell has failed, and in response to the determination that the conditional LTM cell switch towards the target cell has failed, generating a RLF report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates example signaling procedures for inter-gNB handover according to embodiments of the present disclosure;

FIG. 5 illustrates an example procedure for LTM according to embodiments of the present disclosure;

FIG. 6 illustrates an example process for RLF reporting according to embodiments of the present disclosure;

FIG. 7 illustrates another example process for RLF reporting according to embodiments of the present disclosure;

FIG. 8 illustrates another example process for RLF reporting according to embodiments of the present disclosure; and

FIG. 9 illustrates an example method for RLF reporting for LTM according to embodiments of the present disclosure.

### DETAILED DESCRIPTION

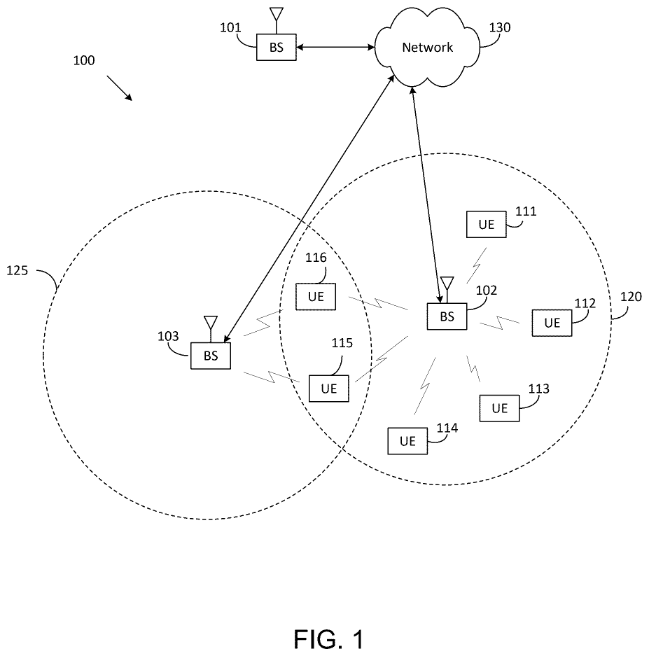

FIGS. 1 through 9, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for RLF reporting for LTM. In certain embodiments, one or more of the gNBs 101-103 includes circuitry, programing, or a combination thereof, to support RLF reporting for LTM in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

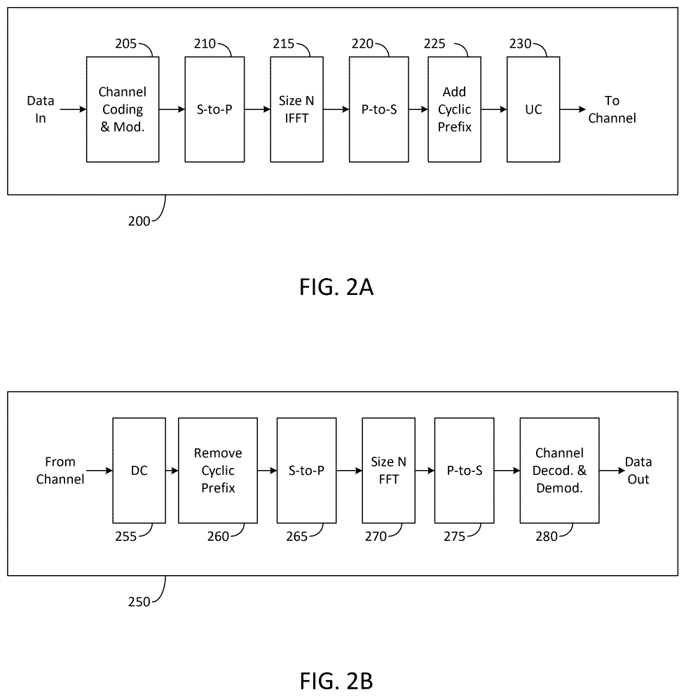

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support RLF reporting for LTM as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

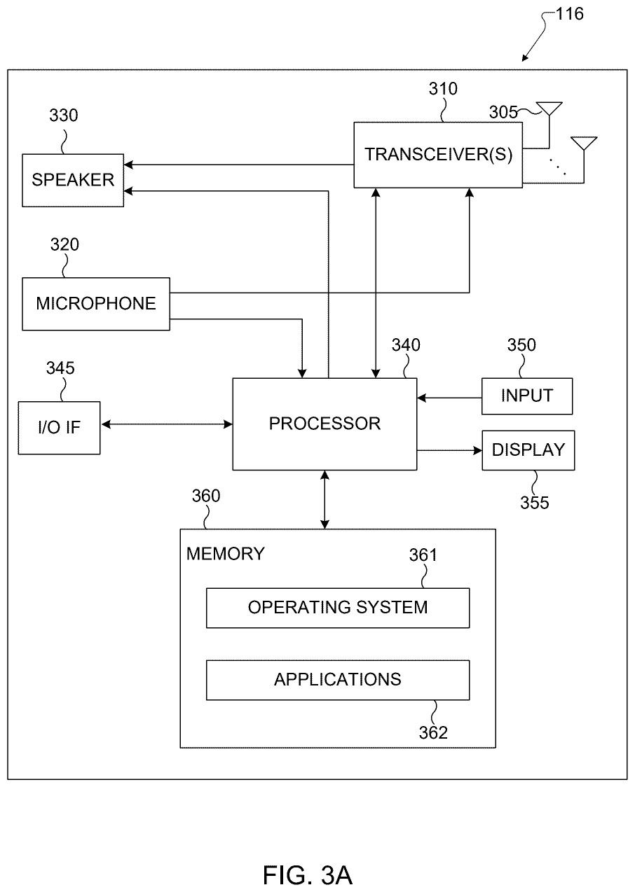

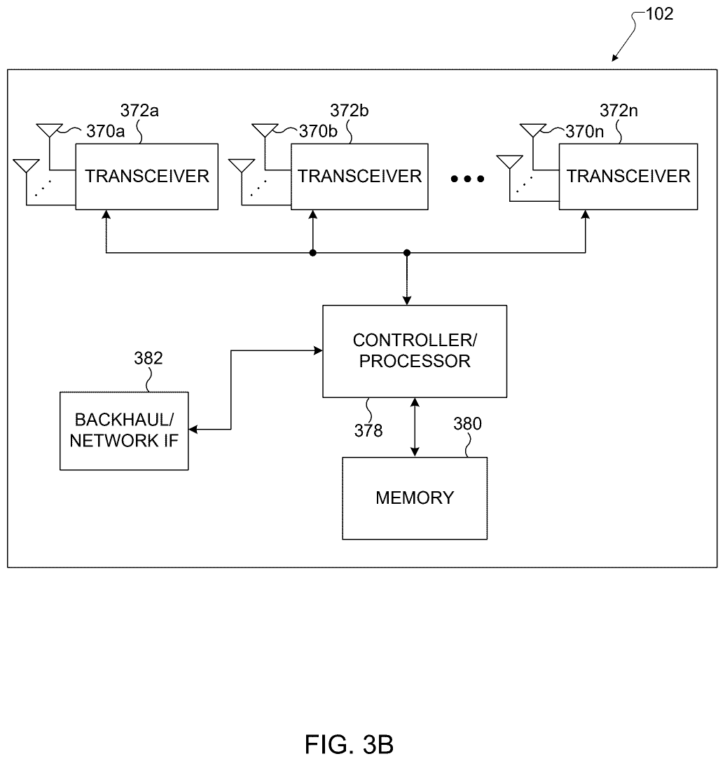

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for RLF reporting for LTM as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support RLF reporting for LTM as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using Beamforming. Beamforming techniques are used to mitigate propagation path losses and to increase propagation distance for communication at higher frequency bands. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in the increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength received from a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred as a transmit (TX) beam. Wireless communication systems operating at high frequency use a plurality of narrow TX beams to transmit signals in the cell as each narrow TX beam provides coverage to a part of a cell. The narrower the TX beam, higher the antenna gain and hence the larger the propagation distance of the signal transmitted using beamforming. A receiver can also generate a plurality of receive (RX) beam patterns of different directions. Each of these receive patterns can be also referred to as a receive (RX) beam.

The next generation wireless communication system (e.g., 5G, beyond 5G, 6G), supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the primary cell (PCell) and optionally one or more SCells. In NR the term Secondary Cell Group (SCG) refers to a group of serving cells associated with the Secondary Node, comprising of the PSCell and optionally one or more secondary cells (SCells). In NR PCell refers to a serving cell in a MCG, operating on the primary frequency, in which the UE either performs the initial connection establishment procedure or initiates the connection re-establishment procedure. In NR for a UE configured with CA, an Scell is a cell providing additional radio resources on top of a Special Cell. A Primary SCG Cell (PSCell) refers to a serving cell in a SCG in which the UE performs random access when performing the Reconfiguration with Sync procedure. For Dual Connectivity operation the term SpCell (i.e., Special Cell) refers to the PCell of the MCG or the PSCell of the SCG. Otherwise, the term Special Cell refers to the PCell.

In the next generation wireless communication system (e.g., 5G, beyond 5G, 6G), a node B (gNB) or base station in cell broadcast Synchronization Signal and PBCH block (SSB) comprises primary and secondary synchronization signals (PSS, SSS) and system information. System information includes common parameters needed to communicate in a cell. In the fifth generation wireless communication system (also referred as next generation radio or NR), System Information (SI) is divided into the master information block (MIB) and a number of system information blocks (SIBs), wherein the MIB may be transmitted on the broadcast channel (BCH) with a periodicity of 80 ms and repetitions made within 80 ms and the MIB includes parameters that are needed to acquire a SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and control resource set (CORESET) multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to an SI message, periodicity, SI-window size) of other SIBs with an indication whether one or more SIBs are only provided on-demand and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to different SI messages. Each SI message is transmitted within periodically occurring time domain windows (referred to as SI-windows with a same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as an SI area, which consists of one or several cells and is identified by systemInformationAreaID; The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network provide system information through dedicated signaling using the RRCReconfiguration message (e.g., if the UE has an active BWP with no common search space configured to monitor system information), paging, or upon request from the UE. In an RRC_CONNECTED state, the UE acquires the required SIB(s) from the PCell. For PSCell and SCells, the network provides the required SI by dedicated signaling (i.e., within an RRCReconfiguration message). Nevertheless, the UE shall acquire the MIB of the PSCell to get SFN timing of the SCG (which may be different from MCG). Upon change of relevant SI for the SCell, the network releases and adds the concerned SCell. For a PSCell, the required SI is changed with Reconfiguration with Sync.

In the next generation wireless communication system (e.g., 5G, beyond 5G, 6G), the Physical Downlink Control Channel (PDCCH) is used to schedule DL transmissions on the physical downlink shared channel (PDSCH) and UL transmissions on the physical uplink shared channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to the uplink shared channel (UL-SCH). In addition to scheduling, the PDCCH can be used to for: activation and deactivation of a configured PUSCH transmission with a configured grant; activation and deactivation of a PDSCH semi-persistent transmission; notifying one or more UEs of the slot format; notifying one or more UEs of the PRB(s) and OFDM symbol(s) where the UE may assume no transmission is intended for the UE; transmission of transmission power control (TPC) commands for the PUCCH and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCEs. Different code rates for the control channels are realized by aggregating different numbers of CCEs. Interleaved and non-interleaved CCE-to-REG mappings are supported in a CORESET. Polar coding is used for the PDCCH. Each resource element group carrying the PDCCH carries its own demodulation reference signal (DMRS). QPSK modulation is used for the PDCCH.

In the next generation wireless communication system (e.g., 5G, beyond 5G, 6G), a list of search space configurations is signaled by the gNB for each configured BWP of the serving cell wherein each search configuration is uniquely identified by a search space identifier. The search space identifier is unique amongst the BWPs of a serving cell. An identifier of the search space configuration to be used for a specific purpose such as paging reception, SI reception, and random access response reception is explicitly signaled by the gNB for each configured BWP. In NR, a search space configuration includes the parameters Monitoring-periodicity-PDCCH-slot, Monitoring-offset-PDCCH-slot, Monitoring-symbols-PDCCH-within-slot and duration. A UE determines the PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in the slots ‘x’ to x+duration where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0;

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with the search space. A list of CORESET configurations are signaled by the gNB for each configured BWP of the serving cell, wherein each CORESET configuration is uniquely identified by a CORESET identifier. The CORESET identifier is unique amongst the BWPs of a serving cell. Note that each radio frame is of 10 ms duration. Each radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each CORESET configuration is associated with a list of transmission configuration indicator (TCI) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (the DL TX beam is QCLed with the SSB/CSI RS of the TCI state) used by gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE monitors the PDCCH on the one active BWP i.e., the UE does not have to monitor the PDCCH on the entire DL frequency of the serving cell. In an RRC connected state, the UE is configured with one or more DL and UL BWPs for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signaling, or by the MAC entity itself upon initiation of Random-Access procedure. Upon addition of an SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

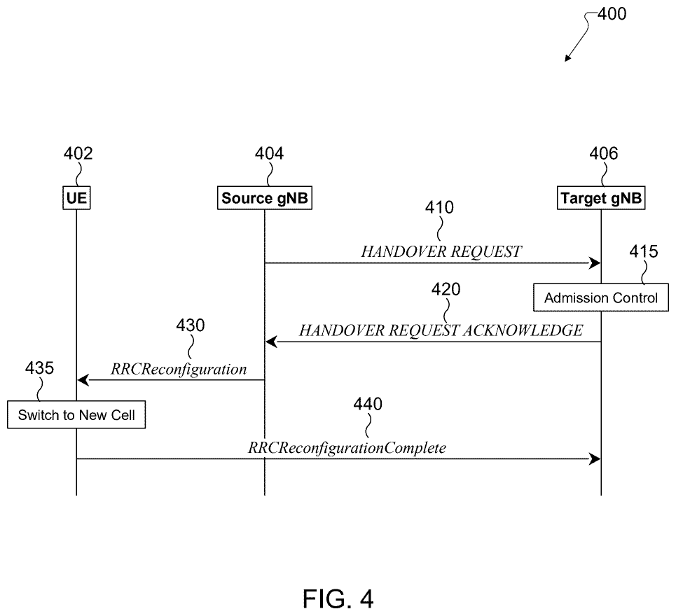

In the next generation wireless communication system (e.g., 5G, beyond 5G, 6G), there are two types of mobility: cell level mobility and beam level mobility. Cell Level Mobility utilizes explicit RRC signaling to be triggering (i.e., handover). For inter-gNB handover, the signaling procedures comprise at least the components shown in FIG. 4.

FIG. 4 illustrates example signaling procedures 400 for inter-gNB handover according to embodiments of the present disclosure. An embodiment of the signaling procedures illustrated in FIG. 4 are for illustration only. One or more of the components illustrated in FIG. 4 may be implemented in specialized circuitry configured to perform the noted functions or one or more of the components may be implemented by one or more processors executing instructions to perform the noted functions. Other embodiments of signaling procedures for inter-gNB handover could be used without departing from the scope of this disclosure.

In the example of FIG. 4, source gNB 404 initiates handover and issues a HANDOVER REQUEST 410 over an Xn interface to a target gNB 406. Target gNB performs admission control at step 415 and provides a new RRC configuration as part of a HANDOVER REQUEST ACKNOWLEDGE 420. Source gNB 404 provides the RRC configuration to UE 402 by forwarding the RRCReconfiguration message 430 received in the HANDOVER REQUEST ACKNOWLEDGE 420. The RRCReconfiguration message 430 includes at least cell ID and all information required to access the target cell so that the UE 402 can access the target cell without reading system information. For some cases, the information required for contention-based and contention-free random access can be included in RRCReconfiguration message 430. The access information to the target cell may include beam specific information, if any. At step 435, UE 402 moves the RRC connection to target gNB 406 and replies with the RRCReconfigurationComplete message 440. The example of FIG. 4 may be referred to as a network controlled or network initiated handover procedure.

Although FIG. 4 illustrates one example of signaling procedures 400 for inter-gNB handover, various changes may be made to FIG. 4. For example, while shown as a series of steps, various steps in FIG. 4 could overlap, occur in parallel, occur in a different order, occur any number of times, be omitted, or replaced by other steps.

In addition to network controlled/network initiated handover, the next generation wireless communication system (e.g., 5G, beyond 5G, 6G) also supports conditional handover and dual active protocol stack (DAPS) handover. In the case of conditional handover, the network can configure one or more candidate cells for conditional handover and one or more L3 measurement based events based on which UE decides to perform a conditional handover procedure. In the case of DAPS handover, the UE continues the downlink user data reception from the source gNB until releasing the source cell and continues the uplink user data transmission to the source gNB until a successful random access procedure to the target gNB.

Layer 1 (L1)/layer 2 (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a MAC CE. The cell switch command indicates an LTM candidate cell configuration that the gNB previously prepared and provided to the UE through RRC signaling. Then the UE switches to the target cell according to the cell switch command. The LTM procedure can be used to reduce mobility latency. The network may request the UE to perform early TA acquisition of a candidate cell before a cell switch. The early TA acquisition is triggered by a PDCCH order or through a UE-based TA measurement.

The network indicates in the cell switch command whether the UE shall access the target cell with a random access (RA) procedure if a TA value is not provided or with a PUSCH transmission using the indicated TA value. For RACH-less LTM, the UE accesses the target cell via the configured grant provided in the RRC signaling and selects the configured grant occasion associated with the beam indicated in the cell switch command. The UE may monitor the PDCCH for dynamic scheduling from the target cell upon an LTM cell switch.

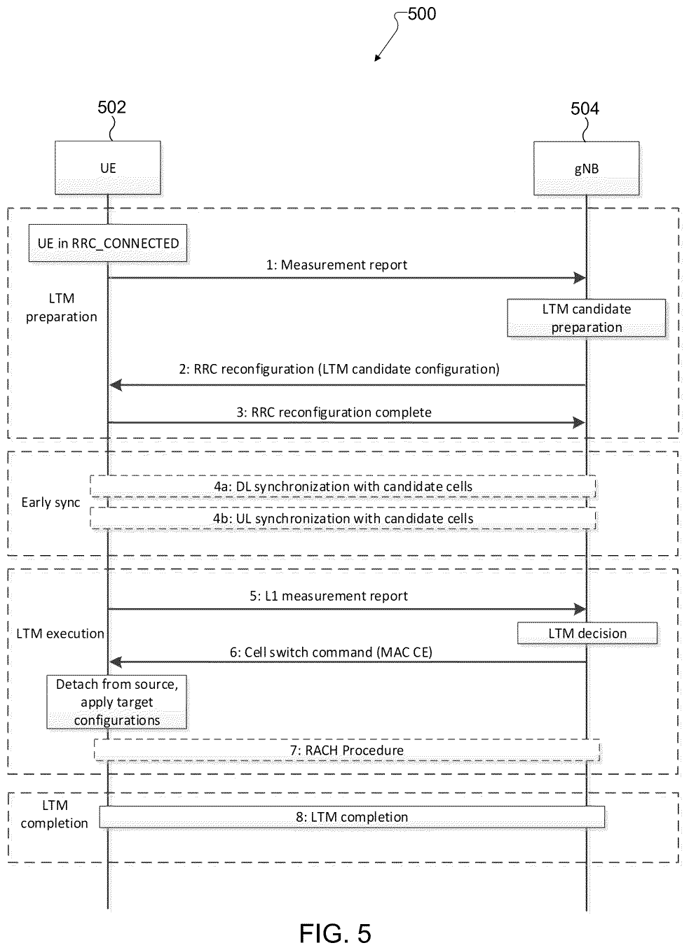

FIG. 5 illustrates an example procedure for LTM 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 5, procedure 500 begins at step 1. At step 1, UE 502, which is in an RRC connected state sends a MeasurementReport message to gNB 504. gNB 504 then decides to configure LTM and initiates candidate cell(s) preparation.

At step 2, gNB 504 transmits an RRCReconfiguration message to UE 502 including the LTM candidate cell configurations of one or multiple candidate cells.

At step 3, UE 502 stores the LTM candidate cell configurations and transmits an RRCReconfigurationComplete message to gNB 504.

At step 4a, UE 502 may perform DL synchronization with candidate cell(s) before receiving a cell switch command.

At step 4b, if requested by the network, UE 502 performs early TA acquisition with candidate cell(s) before receiving the cell switch command. This is done via contention free random access (CFRA) triggered by a PDCCH order from the source cell, following which UE 502 sends a preamble towards the indicated candidate cell. In order to minimize the data interruption of the source cell due to the CFRA towards the candidate cell(s), UE 502 doesn't receive a RAR for the purpose of TA value acquisition and the TA value of the candidate cell is indicated in the cell switch command. UE 502 doesn't maintain the TA timer for the candidate cell and relies on network implementation to guarantee the TA validity.

At step 5, UE 502 performs L1 measurements on the configured candidate cell(s) and transmits L1 measurement reports to the gNB.

At step 6, gNB 504 decides to execute cell switch to a target cell and transmits a MAC CE triggering cell switch by including the candidate configuration index of the target cell. UE 502 switches to the target cell and applies the configuration indicated by the candidate configuration index.

At step 7, UE 502 performs a random access procedure towards the target cell if UE does not have valid TA of the target cell.

At step 8, UE 502 completes the LTM cell switch procedure by sending a RRCReconfigurationComplete message to the target cell. If UE 502 has performed a RA procedure in step 7, UE 502 considers that the LTM execution is successfully completed when the random access procedure is successfully completed. For RACH-less LTM, UE 502 considers that the LTM execution is successfully completed when the UE determines that the network has successfully received its first UL data. UE 502 determines successful reception of its first UL data by receiving a PDCCH addressing UE 502's C-RNTI in the target cell, which schedules a new transmission following the first UL data.

For LTM, the network may indicate one or more L1 measurement based events based on which UE 502 may initiate LTM execution to a candidate LTM cell without receiving a cell switch command from gNB 504. This procedure may be referred as conditional LTM or UE initiated LTM. A list of one or more candidate LTM cells for conditional LTM or UE initiated LTM may be signaled by gNB 504 in an RRCReconfiguration message (step 2).

Although FIG. 5 illustrates one example procedure for LTM 500, various changes may be made to FIG. 5. For example, while shown as a series of steps, various steps in FIG. 5 could overlap, occur in parallel, occur in a different order, occur any number of times, be omitted, or replaced by other steps.

In the next generation wireless communication system (e.g., 5G, beyond 5G, 6G), a UE prepares a radio link failure report upon handover failure, conditional handover failure and DAPS handover failure or radio link failure (RLF). The UE indicates availability of a RLF report in resumeComplete (during a RRC connection resume procedure), setupComplete (during a RRC connection setup procedure) and ReconfigurationComplete (during RRC reconfiguration procedure) messages. A gNB may request an RLF report using rlf-ReportReq in a UEInformationRequest message. The UE sends the requested report to the gNB in a UEInformationResponse message.

The received RLF report helps the network in optimizing the configuration of handover failure, conditional handover failure and DAPS handover failure or radio link failure (RLF). At present is no information reported to the network in case of a UE initiated L1/L2 Triggered Mobility/cell switch failure. So, enhancements to radio link failure reporting for L1/L2 Triggered Mobility/cell switch failure are desirable.

Various embodiments of the present disclosure provide RLF reporting enhancements for reporting for L1/L2 Triggered Mobility/cell switch failure.

In some embodiments, a new handover type ‘CLTM’ may be used for the field lastHO-Type in an RLF report.

In some embodiments, an RLF report may include a new field timeSinceLTM-Reconfig. In the event of a conditional LTM failure, this field can used to indicate the time elapsed between the initiation of the last conditional LTM execution towards the target cell and the reception of the latest conditional LTM reconfiguration. In the event of a radio link failure, this field can be used to indicate the time elapsed between the radio link failure and the reception of the latest conditional LTM reconfiguration while connected to the source PCell.

In some embodiments, an RLF report may include a new field condltmCandidateCellList. This field can be used to indicate the list of candidate target cells for conditional LTM included in condltm-Config at the time of a connection failure. In some embodiments, the field does not include the candidate target cells included in measResulNeighCells.

In some embodiments, an RLF report may include a new field CondltmCellId. This field can be used to indicate the candidate target cell for conditional LTM included in Condltm-Config that the UE selected for conditional LTM based recovery while timer T311 is running.

The present disclosure provides various embodiments of procedures to set/report the new parameters and/or new fields described above.

In some embodiments, a UE, such as UE 116 of FIG. 1, may determine the contents of an RLF report according to the following procedure:

If connectionFailureType is rlf and the rlf-Cause is set to randomAccessProblem or beamFailureRecoveryFailure, or if connectionFailure Type is hof and if the failed handover is an intra-RAT handover, the UE sets the ra-InformationCommon to include the random-access related information. If available, the UE sets the locationInfo.

If the failure is detected due to reconfiguration with sync failure, the UE sets the fields in VarRLF-report as follows:
The UE set the connectionFailure Type to hof.
If the UE supports RLF-Report for DAPS handover and if any DAPS bearer was configured while T304 was running: a) the UE sets lastHO-Type to daps, and b) if radio link failure was detected in the source PCell, the UE sets timeConnSourceDAPS-Failure to the time between the initiation of the DAPS handover execution and the radio link failure detected in the source PCell while timer T304 was running, and set the rlf-Cause to the trigger for detecting the source radio link failure.
If the UE supports RLF-Report for conditional handover and if configuration of the conditional handover is available in the MCG VarConditionalReconfig at the moment of the handover failure:
   If the UE executed a conditional handover toward target PCell according to the condRRCReconfig of the target PCell, the UE sets time SinceCHO-Reconfig to the time elapsed between the execution of the last RRCReconfiguration message including reconfigurationWithSync for the target PCell of the failed conditional handover, and the reception in the source PCell of the last conditionalReconfiguration including the condRRCReconfig of the target PCell of the failed conditional handover. Otherwise, the UE sets timeSinceCHO-Reconfig to the time elapsed between the execution of the last RRCReconfiguration message including reconfigurationWithSync for the target PCell of the failed handover, and the reception in the source PCell of the last conditionalReconfiguration including the condRRCReconfig.
   The UE sets set choCandidateCellList to include the global cell identity, if available, and otherwise to the physical cell identity and carrier frequency of each of the candidate target cells for conditional handover included in condRRCReconfig within the MCG VarConditionalReconfig at the time of the failed handover, excluding the candidate target cells included in measResulNeighCells.
If the UE supports RLF-Report for conditional LTM and if configuration of the conditional LTM is available in the MCG VarCondLTM-UE-Config at the moment of the handover failure (i.e., reconfiguration with sync failure):
   If the UE executed a conditional LTM toward the target PCell according to the conditional LTM configuration of the target PCell, the UE sets timeSinceCondLTM-Reconfig to the time elapsed between the execution of the last RRCReconfiguration message including reconfigurationWithSync for the target PCell of the failed conditional LTM, and the reception in the source PCell of the last Condltm-Config including the conditional LTM configuration of the target PCell of the failed conditional LTM. Otherwise, the UE sets time SinceCondLIM-Reconfig to the time elapsed between the execution of the last RRCReconfiguration message including reconfigurationWithSync for the target PCell of the failed LTM (or failed handover), and the reception in the source PCell of the last Condltm-Config including the conditional LTM configuration.
   The UE sets condltmCandidateCellList to include the global cell identity, if available, and otherwise to the physical cell identity and carrier frequency of each of the candidate target cells for LTM included in ue-CondLTM-Config within the MCG VarCondLIM-UE-Config at the time of the failed handover, excluding the candidate target cells included in measResulNeighCells.
If the UE supports RLF-Report for LTM and if the last executed RRCReconfiguration message including reconfigurationWithSync was concerning a conditional LTM, the UE sets lastHO-Type to cltm.
The UE sets the nrFailedPCellId in failedPCellId to the global cell identity and tracking area code, if available, and otherwise to the physical cell identity and carrier frequency of the target PCell of the failed handover.
The UE includes nrPreviousCell in previousPCellId and sets them to the global cell identity and tracking area code of the PCell where the last RRCReconfiguration message including reconfigurationWithSync was received.
The UE sets timeConnFailure to the elapsed time since the execution of the last RRCReconfiguration message including the reconfigurationWithSync.

Otherwise, if the failure is detected due to radio link failure, the UE set the fields in VarRLF-report as follows:
The UE sets the connectionFailure Type to rlf.
The UE sets the rlf-Cause to the trigger for detecting radio link failure.
The UE sets the nrFailedPCellId in failedPCellId to the global cell identity and the tracking area code, if available, and otherwise to the physical cell identity and carrier frequency of the PCell where radio link failure is detected.
If an RRCReconfiguration message including the reconfigurationWithSync was received before the connection failure:
   if the last successfully executed RRCReconfiguration message including the reconfigurationWithSync concerned an intra NR handover and it was received while connected to the previous PCell to which the UE was connected before connecting to the PCell where radio link failure is detected, and if timer T311 was not running before entering the PCell in which the radio link failure was detected: a) the UE includes the nrPreviousCell in previousPCellId and sets it to the global cell identity and the tracking area code of the PCell where the last executed RRCReconfiguration message including reconfigurationWithSync was received. b) If the last executed RRCReconfiguration message including reconfigurationWithSync was concerning a DAPS handover, the UE sets lastHO-Type to daps. c) Otherwise, if the last executed RRCReconfiguration message including reconfigurationWithSync was concerning a conditional handover, the UE sets lastHO-Type to cho. d) Otherwise, if the last executed RRCReconfiguration message including reconfigurationWithSync was concerning conditional LTM, the UE sets lastHO-Type to cltm. e) Finally, the UE sets timeConnFailure to the elapsed time since the execution of the last RRCReconfiguration message including the reconfigurationWithSync.
   Otherwise, if the last RRCReconfiguration message including the reconfigurationWithSync concerned a handover to NR from E-UTRA and if the UE supports Radio Link Failure Report for Inter-RAT MRO EUTRA, the UE includes the eutraPreviousCell in previousPCellId and sets it to the global cell identity and the tracking area code of the E-UTRA PCell where the last RRCReconfiguration message including reconfigurationWithSync was received embedded in E-UTRA RRC message MobilityFromEUTRACommand message. Then the UE sets timeConnFailure to the elapsed time since reception of the last RRCReconfiguration message including the reconfigurationWithSync embedded in the E-UTRA RRC message MobilityFromEUTRACommand message.
If configuration of the conditional handover is available in the MCG VarConditionalReconfig at the moment of declaring the radio link failure, the UE sets timeSinceCHO-Reconfig to the time elapsed between the detection of the radio link failure, and the reception, in the source PCell, of the last conditionalReconfiguration including the condRRCReconfig message. Then the UE sets choCandidateCellList to include the global cell identity if available, and otherwise to the physical cell identity and carrier frequency of each of all the candidate target cells for conditional handover included in condRRCReconfig within the MCG VarConditionalReconfig at the time of radio link failure, excluding the candidate target cells included in measResulNeighCells.
If configuration of the conditional LTM is available in the MCG VarCondLTM-UE-Config at the moment of declaring the radio link failure, the UE sets timeSinceCondLTM-Reconfig to the time elapsed between the detection of the radio link failure, and the reception, in the source PCell, of the last Condltm-Config. Then the UE sets condltmCandidateCellList to include the global cell identity if available, and otherwise to the physical cell identity and carrier frequency of each of all the candidate target cells for conditional LTM included in ue-CondLTM-Config within the MCG VarCondLIM-UE-Config at the time of radio link failure, excluding the candidate target cells included in measResulNeighCells.

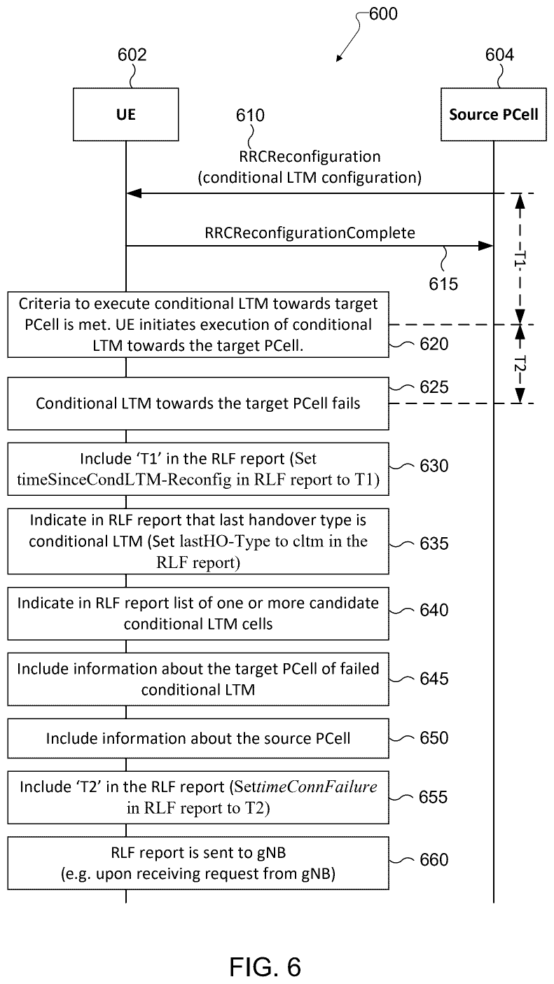

FIG. 6 illustrates an example process for RLF reporting 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a process for RLF reporting could be used without departing from the scope of this disclosure.

In the example of FIG. 6, process 600 begins at step 610. At step 610, UE 602 receives an RRCReconfiguration message from source serving cell 604 (or from a gNB of source serving cell 604, source serving cell 604 may be PCell) and acknowledges the reception at step 615 by sending an RRCReconfigurationComplete message to serving cell 604 (or to a gNB of source serving cell 604). The RRCReconfiguration message may include a conditional LTM configuration for one or more candidate LTM cells. The conditional LTM configuration may include an RRCReconfiguration message for each of the candidate LTM cells, wherein the RRCReconfiguration message includes an Reconfigurationwithsync information element (IE). The conditional LTM configuration may include one or more L1 measurement events/quantities based on which UE 602 determines execution of a conditional LTM to one of the candidate LTM cells.

At step 620, UE 602 initiates execution of a conditional LTM cell switch towards the target PCell (i.e., a candidate from among the conditional LTM candidate cells) when the criteria to execute the conditional LTM cell switch towards the target PCell is met. As part of the execution, UE 602 applies the RRCReconfiguration message including Reconfigurationwithsync IE for the target PCell. UE 602 may start a timer upon initiating the execution of the conditional LTM cell switch towards the target PCell. This timer (e.g., timer “X”) is stopped when execution of the conditional LTM cell switch towards the target PCell is successfully completed (e.g., when a RA procedure towards the target PCell is successfully completed or when UE receives PDCCH addressed to C-RNTI from target PCell).

At step 625, execution of the conditional LTM cell switch towards the target PCell may fail (e.g., when timer “X” is expired). If execution of the conditional LTM cell switch towards the target PCell fails, UE 602 generates an RLF report in response to the failed LTM cell switch as follows:

At step 630, UE 602 includes the time ‘T1’ in the RLF report (i.e., UE 602 sets timeSinceCondLTM-Reconfig in the RLF report to T1, or sets timeSinceCondLTM-Reconfig to the time elapsed between the execution of the last RRCReconfiguration message including reconfigurationWithSync for the target PCell of the failed conditional LTM cell switch, and the reception in the source PCell of the last Condltm-Config including the conditional LTM configuration of the target PCell of the failed conditional LTM).

At step 635, UE 602 indicates in the RLF report that last handover type is a conditional LTM (i.e., UE 602 sets lastHO-Type to cltm in the RLF report).

At step 640, UE 602 indicates in the RLF report a list of one or more candidate conditional LTM cells (i.e., UE 602 sets condltmCandidateCellList to include the global cell identity if available, and otherwise to the physical cell identity and carrier frequency of each of all the candidate target cells for conditional LTM included in ue-CondLIM-Config within the MCG VarCondLIM-UE-Config at the time of radio link failure, excluding the candidate target cells included in measResulNeighCells).

At step 645, UE 602 includes information about the target PCell of the failed conditional LTM cell switch (the information can be the global cell identity and tracking area code, if available, and otherwise the physical cell identity and carrier frequency) in the RLF report.

At step 650, UE 602 includes information about the source PCell (the information can be the global cell identity and tracking area code of the PCell where the last RRCReconfiguration message including reconfigurationWithSync was received) in the RLF report.

At step 655, UE 602 includes time ‘T2’ in the RLF report (i.e., UE 602 sets timeConnFailure in RLF report to T2).

In some embodiments, UE 602 includes location information in the RLF report.

At step 660, UE 602 sends the RLF report (i.e., VarRLF-Report) to a gNB (e.g., upon receiving request from the gNB).

Although FIG. 6 illustrates one example process for RLF reporting 600, various changes may be made to FIG. 6. For example, while shown as a series of steps, various steps in FIG. 6 could overlap, occur in parallel, occur in a different order, occur any number of times, be omitted, or replaced by other steps.

While the operations in the process of FIG. 6 are described as being performed with respect to conditional LTM cell switch, in some embodiments, any of the operations in the process of FIG. 6 may be applied during a network initiated LTM cell switch, and the phrase ‘conditional’ can be omitted in the operations applied for the network initiated LTM cell switch.

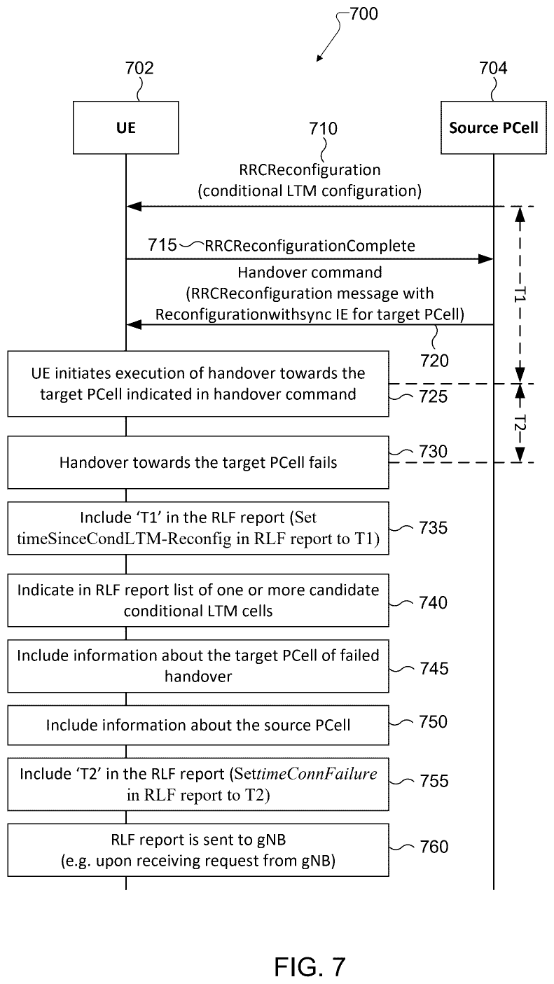

FIG. 7 illustrates another example process for RLF reporting 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a process for RLF reporting could be used without departing from the scope of this disclosure.

In the example of FIG. 7, process 700 begins at step 710. At step 710, UE 702 receives an RRCReconfiguration message from source serving cell 704 (or from a gNB of source serving cell 704, source serving cell 704 may be a PCell) and acknowledges the reception at step 715 by sending an RRCReconfigurationComplete message to serving cell 704 (or to a gNB of source serving cell 704). The RRCReconfiguration message may include a conditional LTM configuration for one or more candidate LTM cells. The conditional LTM configuration may include an RRCReconfiguration message for each of the candidate LTM cells, wherein the RRCReconfiguration message includes a Reconfigurationwithsync IE. The conditional LTM configuration may include one or more L1 measurement events/quantities based on which UE 702 determines execution of a conditional LTM to one of the candidate LTM cells.

At step 720, UE 702 receives a command from the network to handover to a target PCell. The command can be an RRCReconfiguration message which includes a Reconfigurationwithsync IE for the target PCell.

At step 725, UE 702 initiates execution of a handover towards the target PCell. As part of the execution, UE 702 applies the RRCReconfiguration message including the Reconfigurationwithsync IE for the target PCell. UE 702 may start a timer upon initiating execution of the handover towards the target PCell. This timer (e.g., timer “X”) is stopped when execution of the handover towards the target PCell is successfully completed (e.g., when an RA procedure towards the target PCell is successfully completed or when UE 702 receives a PDCCH addressed to a C-RNTI from the target PCell).

At step 730, execution of the handover towards the target PCell may fail (e.g., when timer “X” is expired). If execution of the handover towards the target PCell fails, UE 702 generates an RLF report as follows:

At step 735, UE 702 includes time ‘T1’ in the RLF report (i.e., UE 702 sets timeSinceCondLTM-Reconfig in the RLF report to T1, or sets timeSinceCondLTM-Reconfig to the time elapsed between the execution of the last RRCReconfiguration message including reconfigurationWithSync for the target PCell of the failed handover, and the reception in the source PCell of the last Condltm-Config including the conditional LTM configuration of the target PCell of the failed handover).

At step 740, UE 702 indicates in the RLF report a list of one or more candidate conditional LTM cells (i.e., UE 702 sets condltmCandidateCellList to include the global cell identity if available, and otherwise the physical cell identity and carrier frequency of each of all the candidate target cells for conditional LTM included in ue-CondLIM-Config within the MCG VarCondLIM-UE-Config at the time of radio link failure, excluding the candidate target cells included in measResulNeighCells).

At step 745, UE 702 includes information about the target PCell of the failed handover (the information can be a global cell identity and tracking area code, if available, and otherwise the physical cell identity and carrier frequency) in the RLF report.

At step 750, UE 702 includes information about the source PCell (the information can be the global cell identity and tracking area code of the PCell where the last RRCReconfiguration message including reconfigurationWithSync was received) in the RLF report.

At step 755, UE 702 includes time ‘T2’ in the RLF report (i.e., UE 702 sets timeConnFailure in the RLF report to T2).

In some embodiments, UE 702 includes location information in the RLF report.

At step 760, UE 702 sends the RLF report (i.e., VarRLF-Report) to a gNB (e.g., upon receiving a request from the gNB).

Although FIG. 7 illustrates one example process for RLF reporting 700, various changes may be made to FIG. 7. For example, while shown as a series of steps, various steps in FIG. 7 could overlap, occur in parallel, occur in a different order, occur any number of times, be omitted, or replaced by other steps.

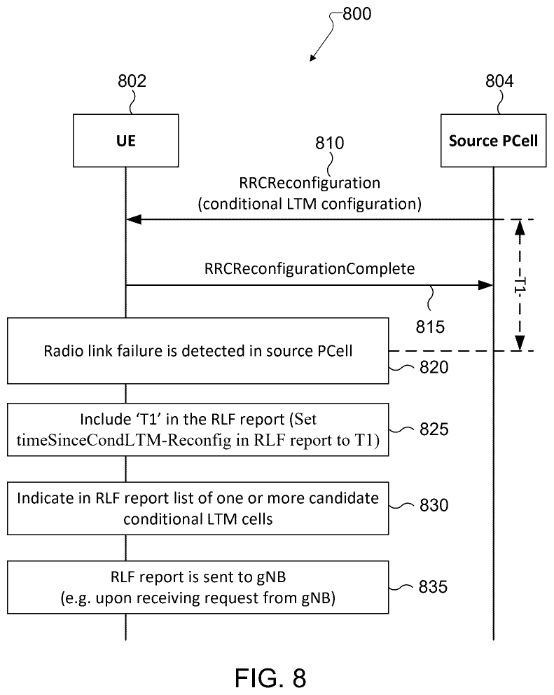

FIG. 8 illustrates another example process for RLF reporting 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a process for RLF reporting could be used without departing from the scope of this disclosure.

In the example of FIG. 8, process 800 begins at step 810. At step 810, UE 802 receives an RRCReconfiguration message from source serving cell 804 (or from a gNB of source serving cell 804, source serving cell 804 may be a PCell) and acknowledges the reception at step 815 by sending an RRCReconfigurationComplete message to serving cell 804 (or to a gNB of source serving cell 804). The RRCReconfiguration message may include a conditional LTM configuration for one or more candidate LTM cells. The conditional LTM configuration may include an RRCReconfiguration message for each of the candidate LTM cells, wherein the RRCReconfiguration message includes a Reconfigurationwithsync IE. The conditional LTM configuration may include one or more L1 measurement events/quantities based on which UE 802 determines execution of a conditional LTM to one of the candidate LTM cells.

At step 820, a radio link failure may be detected in the source PCell. If a radio link failure is detected in the source PCell, UE 802 generates an RLF report as follows:

At step 825, UE 802 includes time ‘T1’ in the RLF report (i.e., UE 802 sets timeSinceCondLTM-Reconfig in the RLF report to T1, or sets timeSinceCondLTM-Reconfig to the time elapsed between the detection of the radio link failure, and the reception, in the source PCell, of the last Condltm-Config).

At step 830, UE 802 indicates in the RLF report a list of one or more candidate conditional LTM cells (i.e., UE 802 sets condltmCandidateCellList to include the global cell identity if available, and otherwise to the physical cell identity and carrier frequency of each of all the candidate target cells for conditional LTM included in ue-CondLIM-Config within the MCG VarCondLTM-UE-Config at the time of radio link failure, excluding the candidate target cells included in measResulNeighCells).

In some embodiments, UE 802 sets the connectionFailureType to rlf.

In some embodiments, UE 802 includes location information in the RLF report.

At step 835, UE 802 sends the RLF report (i.e., VarRLF-Report) to a gNB (e.g., upon receiving a request from the gNB).

Although FIG. 8 illustrates one example process for RLF reporting 800, various changes may be made to FIG. 8. For example, while shown as a series of steps, various steps in FIG. 8 could overlap, occur in parallel, occur in a different order, occur any number of times, be omitted, or replaced by other steps.

In some embodiments, a UE may initiate a re-establishment procedure to recover from handover failures/radio link failures. In some embodiments, upon initiating a re-establishment procedure, the UE starts timer T311 and performs cell selection. Upon selecting the cell while T311 is running, the UE performs the following operation:

If the cell selection is triggered by detecting a radio link failure of the MCG or a re-configuration with sync failure of the MCG or a mobility from NR failure, and if attemptCondReconfig is configured, and if the selected cell is not configured with CondEventT1, or the selected cell is configured with CondEventT1 and a leaving condition has not been fulfilled, and if the selected cell is one of the candidate cells for which the reconfigurationWithSync is included in the masterCellGroup in the MCG VarConditionalReconfig:
If the UE supports RLF-Report for conditional handover, the UE sets the choCellId in the VarRLF-Report to the global cell identity, if available. Otherwise, the UE sets it to the physical cell identity and carrier frequency of the selected cell.
The UE applies the stored condRRCReconfig associated to the selected cell and performs predetermined actions.

If the cell selection is triggered by detecting a radio link failure of the MCG or a re-configuration with sync failure of the MCG or a mobility from NR failure, and if attemptCondLTM-Switch (attemptCondLTM-Switch can be included in a conditional LTM configuration received in an RRCReconfiguration message) is configured, and if the selected cell is one of the LTM candidate cells in ue-CondLIM-Config within VarCondLIM-UE-Config (VarCondLTM-UE-Config stores the conditional LTM configuration received in the RRCReconfiguration message):
If the UE supports RLF-Report for conditional LTM, the UE sets the CondltmCellId in the VarRLF-Report to the global cell identity, if available. Otherwise, the UE sets it to the physical cell identity and carrier frequency of the selected cell.
The UE performs the conditional LTM cell switch procedure for the selected LTM candidate cell.

In case this conditional LTM cell switch procedure fails, UE may send a RRCReestablishmentRequest message to the gNB. The UE may receive an RRCSetup message from gNB in response.

In some embodiments, if the UE receives an RRCSetup message from the gNB, the UE performs the following operation:

If the UE has a radio link failure or handover failure information available in VarRLF-Report, and if the RPLMN is included in plmn-IdentityList stored in VarRLF-Report, if reconnectCellId in VarRLF-Report is not set after failing to perform reestablishment and if this is the first RRCSetup received by the UE after declaring the failure:
If the UE supports RLF-Report for conditional handover and if choCellId in VarRLF-Report is set, the UE sets time UntilReconnection in VarRLF-Report to the time that elapsed since the radio link failure or handover failure experienced in the failedPCellId stored in VarRLF-Report. Otherwise, if the UE supports RLF-Report for Conditional LTM, and if CondltmCellId (CondltmCellId in the RLF report is used to indicate the candidate target cell for conditional LTM included in Condltm-Config that the UE selected for conditional LTM based recovery while T311 is running) in VarRLF-Report is set, the UE sets time UntilReconnection in VarRLF-Report to the time that elapsed since the radio link failure or handover failure experienced in the failedPCellId stored in VarRLF-Report.
Otherwise, the UE sets time UntilReconnection in VarRLF-Report to the time that elapsed since the last radio link failure or handover failure.
the UEsets nrReconnectCellId in reconnectCellId in VarRLF-Report to the global cell identity and the tracking area code of the PCell.

The RLF report (VarRLF-Report) is sent to a gNB (e.g., upon receiving request from gNB).

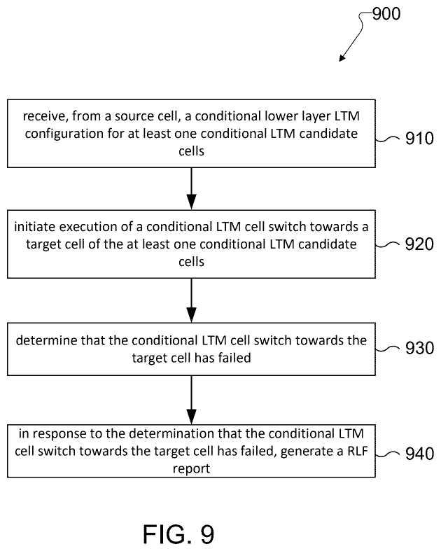

FIG. 9 illustrates an example method for RLF reporting for LTM 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method for RLF reporting for LTM could be used without departing from the scope of this disclosure.

In the Example of FIG. 9, method 900 begins at step 910. At step 910, a UE, such as 116 of FIG. 1, receives, from a source cell (e.g., from BS 102 of FIG. 1), a conditional LTM configuration for at least one conditional LTM candidate cells.

At step 920, the UE initiates execution of a conditional LTM cell switch towards a target cell of the at least one conditional LTM candidate cells.

At step 930, the UE determines that the conditional LTM cell switch towards the target cell has failed.

Finally, at step 940, in in response to the determination that the conditional LTM cell switch towards the target cell has failed, the UE generates a RLF report.

In some embodiments, method 900 further includes receiving, from a BS, a request for the RLF report, and in response to receiving the request, transmitting, to the BS, the RLF report.

In some embodiments, method 900 further includes detecting an RLF in the source cell, and in response to detection of the RLF in the source cell, generating the RLF report. In these embodiments, the RLF report may include at least one of an elapsed time between reception of the conditional LTM configuration and the detection of the RLF in the source cell, and the conditional LTM configuration may be a latest received conditional LTM configuration from the source cell.

In some embodiments, method 900 further includes receiving a handover command, initiating a handover towards a cell indicated by the handover command, determining that the handover has failed, and in response to the determination that handover has failed, generating the RLF report. In these embodiments, the RLF report may include at least one of an elapsed time between reception of the conditional LTM configuration and the initiation of the handover, a global cell identity of the cell indicated by the handover command, a tracking area code of the cell indicated by the handover command, a physical cell identity of the cell indicated by the handover command, a frequency of the cell indicated by the handover command, and an elapsed time since the initiation of the handover.

In some embodiments, the RLF report includes an elapsed time between reception of the conditional LTM configuration and the execution of the conditional LTM cell switch towards the target cell, and the conditional LTM configuration is a latest received conditional LTM configuration of the target cell that failed.

In some embodiments, the RLF report includes an elapsed time since the execution of the conditional LTM cell switch.

In some embodiments, the RLF report includes an indication that the RLF report corresponds to the failed conditional LTM cell switch.

In some embodiments, the RLF report includes at least one of global cell identities of the at least one conditional LTM candidate cells, physical cell identities of the at least one conditional LTM candidate cells, and frequencies of the at least one conditional LTM candidate cells.

In some embodiments, the RLF report includes at least one of a global cell identity of the target cell corresponding to the failed conditional LTM cell switch, a tracking area code of the target cell corresponding to the failed conditional LTM cell switch, a physical cell identity of the target cell corresponding to the failed conditional LTM cell switch, and a frequency of the target cell corresponding to the failed conditional LTM cell switch.

In some embodiments, the RLF report includes at least one of a global cell identity of the source cell, a tracking area code of the source cell, a physical cell identity of the source cell, and a frequency of the source cell.

Although FIG. 9 illustrates one example method for RLF reporting for LTM 900, various changes may be made to FIG. 9. For example, while shown as a series of steps, various steps in FIG. 9 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a source cell, a conditional lower layer triggered mobility (LTM) configuration for at least one conditional LTM candidate cells; and
a processor operatively coupled to the transceiver, the processor configured to:
initiate execution of a conditional LTM cell switch towards a target cell of the at least one conditional LTM candidate cells;
determine that the conditional LTM cell switch towards the target cell has failed; and
in response to the determination that the conditional LTM cell switch towards the target cell has failed, generate a radio link failure (RLF) report.

2. The UE of claim 1, wherein:
the RLF report includes an elapsed time between reception of the conditional LTM configuration and the execution of the conditional LTM cell switch towards the target cell, and
the conditional LTM configuration is a latest received conditional LTM configuration of the target cell that failed.

3. The UE of claim 1, wherein the RLF report includes an indication that the RLF report corresponds to the failed conditional LTM cell switch.

4. The UE of claim 1, wherein the RLF report includes at least one of:
global cell identities of the at least one conditional LTM candidate cells,
physical cell identities of the at least one conditional LTM candidate cells, and
frequencies of the at least one conditional LTM candidate cells.

5. The UE of claim 1, wherein the RLF report includes at least one of:
a global cell identity of the target cell corresponding to the failed conditional LTM cell switch,
a tracking area code of the target cell corresponding to the failed conditional LTM cell switch,
a physical cell identity of the target cell corresponding to the failed conditional LTM cell switch, and
a frequency of the target cell corresponding to the failed conditional LTM cell switch.

6. The UE of claim 1, wherein the RLF report includes at least one of:
a global cell identity of the source cell,
a tracking area code of the source cell,
a physical cell identity of the source cell, and
a frequency of the source cell.

7. The UE of claim 1, wherein the RLF report includes an elapsed time since the execution of the conditional LTM cell switch.

8. The UE of claim 1, wherein the transceiver is further configured to:
receive, from a base station (BS), a request for the RLF report; and
in response to reception of the request, transmit, to the BS, the RLF report.

9. The UE of claim 1 wherein the processor is further configured to:
detect an RLF in the source cell; and
in response to detection of the RLF in the source cell, generate the RLF report,
wherein the RLF report includes at least one of an elapsed time between reception of the conditional LTM configuration and the detection of the RLF in the source cell, and
wherein the conditional LTM configuration is a latest received conditional LTM configuration from the source cell.

10. The UE of claim 1, wherein:
the transceiver is further configured to receive a handover command;
the processor is further configured to:
initiate a handover towards a cell indicated by the handover command;
determine that the handover has failed; and
in response to the determination that handover has failed, generate the RLF report; and
the RLF report includes at least one of:
an elapsed time between reception of the conditional LTM configuration and the initiation of the handover,
a global cell identity of the cell indicated by the handover command,
a tracking area code of the cell indicated by the handover command,
a physical cell identity of the cell indicated by the handover command,
a frequency of the cell indicated by the handover command, and
an elapsed time since the initiation of the handover.

11. A method of operating a user equipment (UE), the method comprising:
receiving, from a source cell, a conditional lower layer triggered mobility (LTM) configuration for at least one conditional LTM candidate cells;
initiating execution of a conditional LTM cell switch towards a target cell of the at least one conditional LTM candidate cells;
determining that the conditional LTM cell switch towards the target cell has failed; and
in response to the determination that the conditional LTM cell switch towards the target cell has failed, generating a radio link failure (RLF) report.

12. The method of claim 11, wherein:
the RLF report includes an elapsed time between reception of the conditional LTM configuration and the execution of the conditional LTM cell switch towards the target cell, and
the conditional LTM configuration is a latest received conditional LTM configuration of the target cell that failed.

13. The method of claim 11, wherein the RLF report includes an indication that the RLF report corresponds to the failed conditional LTM cell switch.

14. The method of claim 11, wherein the RLF report includes at least one of:
global cell identities of the at least one conditional LTM candidate cells,
physical cell identities of the at least one conditional LTM candidate cells, and
frequencies of the at least one conditional LTM candidate cells.

15. The method of claim 11, wherein the RLF report includes at least one of:
a global cell identity of the target cell corresponding to the failed conditional LTM cell switch,
a tracking area code of the target cell corresponding to the failed conditional LTM cell switch,
a physical cell identity of the target cell corresponding to the failed conditional LTM cell switch, and
a frequency of the target cell corresponding to the failed conditional LTM cell switch.

16. The method of claim 11, wherein the RLF report includes at least one of:
a global cell identity of the source cell,
a tracking area code of the source cell,
a physical cell identity of the source cell, and
a frequency of the source cell.

17. The method of claim 11, wherein the RLF report includes an elapsed time since the execution of the conditional LTM cell switch.

18. The method of claim 11, further comprising:
receiving, from a base station (BS), a request for the RLF report; and
in response to receiving the request, transmitting, to the BS, the RLF report.

19. The method of claim 11 further comprising:
detecting an RLF in the source cell; and
in response to detection of the RLF in the source cell, generating the RLF report,
wherein the RLF report includes at least one of an elapsed time between reception of the conditional LTM configuration and the detection of the RLF in the source cell, and
wherein the conditional LTM configuration is a latest received conditional LTM configuration from the source cell.

20. The method of claim 11, further comprising:
receiving a handover command;
initiating a handover towards a cell indicated by the handover command;
determining that the handover has failed; and
in response to the determination that handover has failed, generating the RLF report, wherein the RLF report includes at least one of:
an elapsed time between reception of the conditional LTM configuration and the initiation of the handover,
a global cell identity of the cell indicated by the handover command,
a tracking area code of the cell indicated by the handover command,
a physical cell identity of the cell indicated by the handover command,
a frequency of the cell indicated by the handover command, and
an elapsed time since the initiation of the handover.
